(19) United States
(12) Patent Application Publication
(10) Pub. No.: US 2006/0072891 A1
(43) Pub. Date: Apr. 6, 2006

(54) Methods of manufacturing mold for patterning lower cladding layer of wavelength filter and of manufacturing waveguide-type wavelength filter using the mold

(75) Inventors: Ki-Dong Lee, Seongnam-si (KR); Seh-Won Ahn, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/242,681

(22) Filed: Oct. 3, 2005

(30) Foreign Application Priority Data
Oct. 4, 2004 (KR) 10-2004-0078805

(51) Int. Cl. G02B 6/10

(52) U.S. Cl. 385/129

(57) ABSTRACT

Disclosed herein is a method of manufacturing a mold for patterning a lower cladding layer of a wavelength filter, which includes a) etching a substrate to form a grating pattern on the substrate; b) preparing an etching mask for an optical waveguide pattern and then etching the substrate using the etching mask; and c) removing the etching mask. In addition, a method of manufacturing a waveguide-type wavelength filter is also provided, including a) applying a lower cladding layer on a substrate; b) patterning the lower cladding layer, using the mold; c) setting the pattern of the mold in the lower cladding layer and then removing the mold; and d) sequentially forming a core layer and an upper cladding layer.

### CROSS REFERENCE TO RELATED APPLICATIONS

Pursuant to 35 U.S.C. § 119(a), this application claims the benefit of earlier filing date and right of priority to Korean Patent Application No. 10-2004-0078805, filed on Oct. 4, 2004, the content of which is hereby incorporated by reference herein in its entirety.

### BACKGROUND OF THE INVENTION

1. Field of the Invention

The present invention relates, generally, to methods of manufacturing a mold for patterning a lower cladding layer of a wavelength filter and of manufacturing a waveguide-type wavelength filter using the mold, and, more particularly, to a method of manufacturing a wavelength filter for use in a wavelength division multiplexing optical communication system.

2. Description of the Related Art

In general, a wavelength filter, which is a major part of a wavelength division multiplexing optical communication system, is capable of selecting light of a particular wavelength from among optical signal channels having various wavelengths for transmission of a desired signal. The typical example of a wavelength filter disclosed in the related art is a fiber Bragg grating, which is formed by radiating UV light onto a photosensitive optical fiber through a phase mask. Despite its superior characteristics, the fiber Bragg grating is disadvantageous because it is difficult to reduce the size of the optical fiber and to integrate it with other optical devices, and because it is not easily manufactured on a large scale. To solve the above problems, thorough efforts have been made to develop a waveguide-type wavelength filter, which may be manufactured using a semiconductor fabrication process.

The waveguide-type device has excellent productivity and a small size which makes it easier to integrate with a number of devices. Examples of a waveguide-type device commercially available include arrayed waveguide grating (AWG), power splitters, variable optical attenuators, optical switches, etc., almost all of which have been made mainly of silica. In recent years, while a polymer material having little processing loss in the optical communication wavelength range has been developed, a device benefiting from excellent thermal and optical properties of the polymer material has appeared. Further, unreliability, which is the worst drawback of the polymer material, may be overcome, thanks to the improvement of the material and the development of packaging techniques.

The waveguide-type wavelength filter is manufactured in such a manner that a grating is formed in the direction of travel of the optical signal over the optical waveguide to cause the refractive index to periodically vary in the longitudinal direction of the waveguide. With reference to FIG. 1, a general waveguide-type wavelength filter is shown. As shown in FIG. 1, when light comprising N wavelengths including λ₁, λ₂, . . . , λ_{N} is incident on the wavelength filter, light of a wavelength satisfying the following condition is reflected, while light of the other wavelengths passes through the wavelength filter. The condition represented by Equation 1 below is referred to as a Bragg condition:
λ₂=2n_{eff}Λ Equation 1
wherein n_{eff} is an effective refractive index, and Λ is a grating period.

In FIG. 1, the wavelength filter is shown only up to a core layer, with the omission of an upper cladding layer, for convenience.

With the goal of manufacturing the wavelength filter as noted above using a conventional semiconductor process, a manufacturing process including many steps is required. In particular, since a process of forming a fine grating is included, mass production of wavelength filters is difficult. Therefore, although laser direct-write lithography or laser interference lithography is proposed to form a fine grating pattern, it cannot assure a desired patterning time and yield and is thus unsuitable for the mass production of wavelength filters.

### SUMMARY OF THE INVENTION

Accordingly, the present invention has been made keeping in mind the problems occurring in the related art, and an object of the present invention is to provide a method of manufacturing a mold, which can be used to simultaneously form an optical waveguide pattern and a grating pattern.

Another object of the present invention is to provide a method of manufacturing a wavelength filter using the mold.

According to a first embodiment of the present invention for achieving the above objects, a method of manufacturing a mold for patterning a lower cladding layer of a wavelength filter is provided, comprising a) etching a substrate to form a grating pattern on the substrate; b) preparing an etching mask for an optical waveguide pattern and then etching the substrate using the etching mask; and c) removing the etching mask.

In the method of the present invention, the formation of the grating pattern in a) may be conducted by forming a photoresist pattern using laser interference lithography, and then forming a desired grating pattern using a reactive ion etching process.

According to a second embodiment of the present invention, a method of manufacturing a mold for patterning a lower cladding layer of a wavelength filter is provided, comprising a) forming an optical waveguide pattern on a substrate; b) applying a planarization polymer layer on the optical waveguide pattern, and then forming a grating pattern on the planarization polymer layer, and c) removing the planarization polymer layer with the exception of the grating pattern formed on the optical waveguide pattern.

In the method of the present invention, the substrate used in a) may preferably be a transparent substrate or a semiconductor substrate.

Further, the present invention provides a method of manufacturing a waveguide-type wavelength filter, comprising a) applying a lower cladding layer on a substrate; b) patterning the lower cladding layer using the mold; c) setting the pattern of the mold in the lower cladding layer and then removing the mold; and d) sequentially forming a core layer and an upper cladding layer.

In the method of the present invention, the patterning of the lower cladding layer in b) may be conducted by reprinting the pattern of the mold onto the lower cladding layer using a thermal imprinting process or a UV imprinting process.

In the method of the present invention, the setting of the pattern of the mold in c) may be conducted using heat or UV light.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a general waveguide-type wavelength filter,

FIGS. 2a and 2b are sectional views showing a wavelength filter of the present invention;

FIGS. 3a to 3d are perspective views showing a process of manufacturing a mold for patterning the lower cladding layer of a wavelength filter, according to a first embodiment of the present invention;

FIGS. 4a to 4d are perspective views showing a process of manufacturing a mold for patterning the lower cladding layer of a wavelength filter, according to a second embodiment of the present invention;

FIGS. 5a to 5e are sectional views showing a process of manufacturing a wavelength filter of the present invention;

FIG. 6 is a photograph showing the mold for use in the manufacture of the wavelength filter of the present invention; and

FIG. 7 is a photograph showing the lower cladding layer manufactured through an imprinting process using the mold of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout The description of known functions and structures, which is considered unnecessary in the present invention, is omitted.

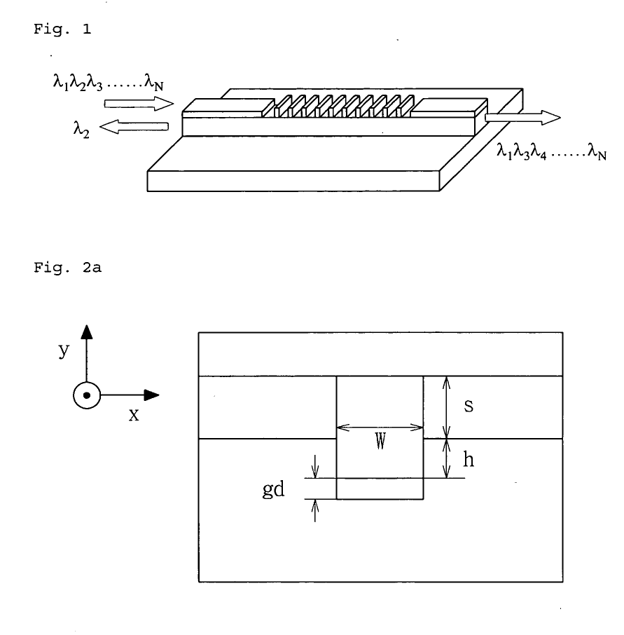

FIGS. 2a and 2b are sectional views showing a waveguide-type wavelength filter, according to the present invention.

FIG. 2a shows the section (x-y plane) of the wavelength filter, and FIG. 2b shows the side section (y-z plane) thereof, in which an optical signal is assumed to travel in a +z direction.

In these drawings, the structure of the waveguide-type wavelength filter is schematically seen.

In the wavelength filter of FIG. 2a, W is the width of a waveguide, s is the thickness of a waveguide slab, h is the thickness of a core layer rib, and gd is the thickness of the waveguide overlapping a lower cladding layer.

The section shape of the optical waveguide shown in FIGS. 2a and 2b is in the form of an inverted rib optical waveguide, and thus, a grating is formed at the lower portion of the waveguide. The period of the grating varies with the wavelength of light used, and is generally determined to satisfy a Bragg condition. Although the period of the grating is determined depending on the Bragg condition, it preferably ranges from 400 to 600 μm in the presence of an optical signal near 1.55 μm serving as a main wavelength of optical communication. Further, it is preferable that the depth of the grating be in the range of 0.1˜1.5 μm when the thickness h of the core layer rib is 3 μm.

In the present invention, to manufacture an optical waveguide-type wavelength filter, through which only a wavelength mainly used for optical communication is transmitted, the optical waveguide preferably has a width W of 6 μm, a thickness s of the waveguide slab of 3 μn, a refractive index of the polymer of upper and lower cladding layers of 1.445, and a refractive index of the polymer of the core layer of 1.46.

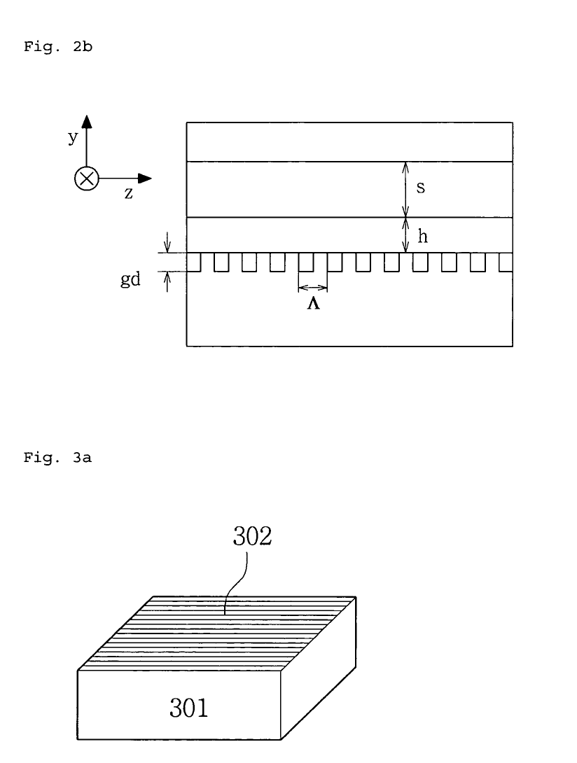

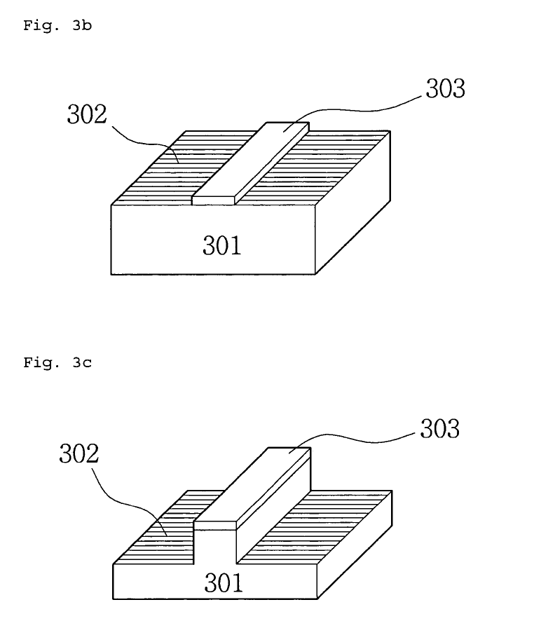

FIGS. 3a to 3d are perspective views showing the process of manufacturing a mold for patterning a lower cladding layer of a wavelength filter, according to a first embodiment of the present invention.

In order to manufacture the waveguide-type wavelength filter, a mold is first manufactured.

FIG. 3a is the process of forming a grating pattern 302 on a substrate 301. Specifically, on the substrate 301, a photoresist pattern is formed using laser interference lithography, after which the substrate 301 is etched using a reactive ion etching process, thus forming a grating pattern 302 on the substrate 301. The substrate 301 includes, for example, a transparent substrate, such as quartz glass, or a semiconductor substrate, such as silicon.

That is, on the quartz glass substrate or silicon semiconductor substrate, the photoresist pattern having a grating shape is formed using a diffraction phenomenon caused by the laser interference. The period of the grating shape formed using a diffraction phenomenon is preferably determined by the properties of a filter of an optical waveguide to be manufactured. The substrate, on which the photoresist pattern having a grating shape is formed, is etched, to form a desired grating pattern on the substrate. The photoresist-coated portions are not etched by the subsequent etching process. Hence, the photoresist-coated portions protrude, while the portions without photoresist are etched, thus forming an irregular grating pattern.

FIG. 3b shows the process of preparing an etching mask 303. Specifically, the etching mask 303 for an optical waveguide pattern is formed on the grating pattern 302 using general photolithography and etching. In the case where the substrate is a quartz glass substrate, a chromium (Cr) pattern may be used as the etching mask. That is, in the case of using the quartz glass substrate, the grating pattern is formed on the quartz glass substrate according to the process shown in FIG. 3a, after which a chromium layer is formed on the quartz glass substrate. Then, a photoresist having a predetermined width is formed on the chromium layer. As such, the width of the photoresist should equal the width W of a subsequently formed optical waveguide. After the photoresist is formed, the chromium layer present on the portions with the exception of the photoresist-coated portions is removed using an etching process, and further, the photoresist is removed. Thereby, a desired etching mask 303 formed of chromium and having a predetermined width is formed on the quartz glass substrate.

FIG. 3c shows the process of etching the substrate 301 using the etching mask 303. The etching process is well-known to those skilled in the art, and thus a detailed description thereof is omitted. The substrate is etched to a depth equal to the thickness gd of a subsequently formed optical waveguide, which overlaps the lower cladding layer. Even after the etching process, the grating pattern formed in FIG. 3a remains on the etched surface.

FIG. 3d shows the process of removing the etching mask 303 to complete a mold for use in the manufacture of a wavelength filter. The completed mold has a grating pattern formed on the entire upper surface thereof including the optical waveguide region. The etching mask 303 is removed using a general etching process.

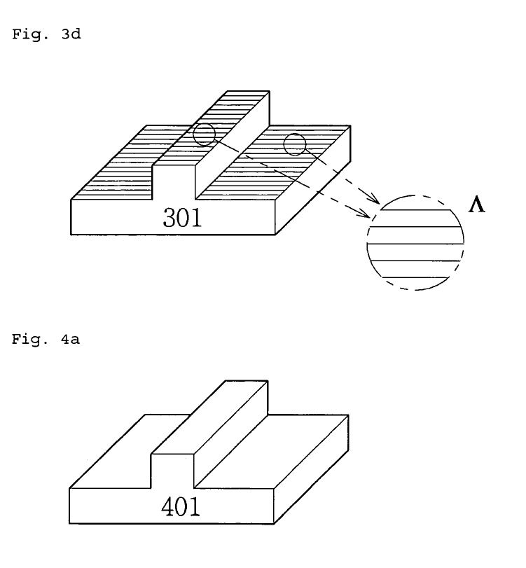

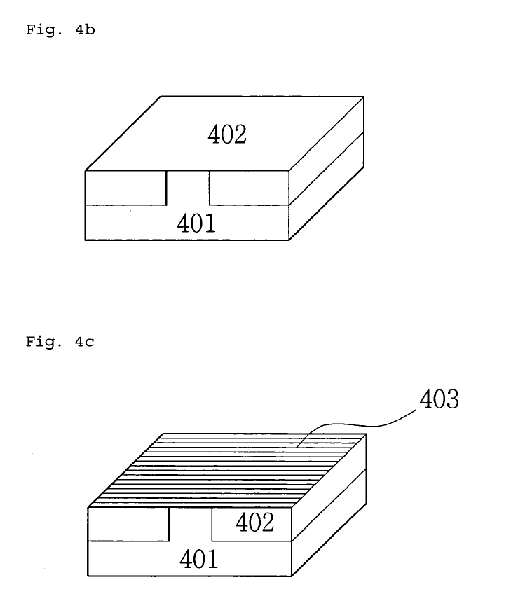

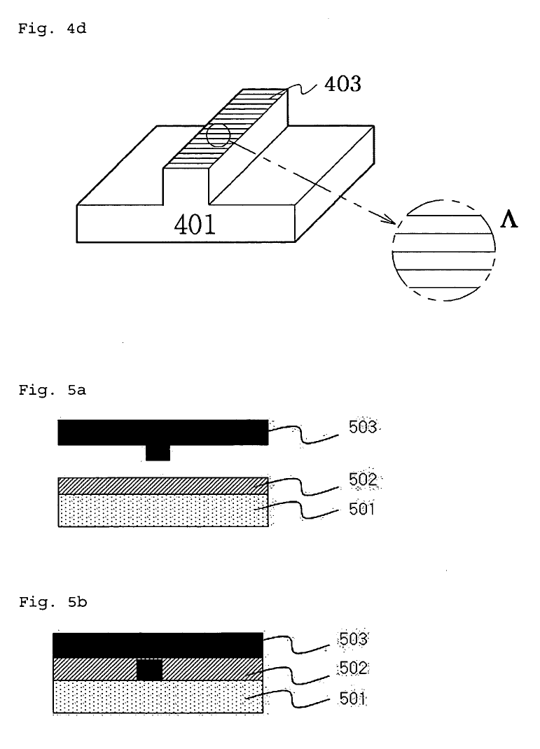

Turning now to FIGS. 4a to 4d, there are illustrated perspective views showing the process of manufacturing a mold for patterning a lower cladding layer of a wavelength filter, according to a second embodiment of the present invention.

First, an optical waveguide pattern is formed on a substrate 401 using photolithography and etching (FIG. 4a). The width of the optical waveguide pattern is the same as that of an optical waveguide to be actually formed, and the depth of the pattern equals the thickness gd of the optical waveguide overlapping the lower cladding layer.

The upper surface of the optical waveguide pattern thus formed is coated with a planarization polymer layer 402 (FIG. 4b). The upper surface of the optical waveguide pattern formed on the substrate 401 using an etching process may be irregular, and such irregularity results in non-uniformity of a subsequently formed grating pattern. Therefore, the upper surface of the optical waveguide pattern is planarized using the planarization polymer layer 402.

A grating pattern 403 is formed on the planarization polymer layer 402 using laser interference lithography, after which the grating pattern 403 is formed on the waveguide pattern using a reactive ion etching process (FIG. 4c). This procedure is conducted in the same manner as in FIG. 3a, with the exception that the grating pattern is not formed on the entire upper surface of the substrate but is formed only on the planarization polymer layer.

Finally, the planarization polymer layer 402 is removed, to complete a desired mold (FIG. 4d). Since the mold thus obtained has the grating formed only on the upper surface of the optical waveguide pattern, the properties of the wavelength filter are easy to accurately control.

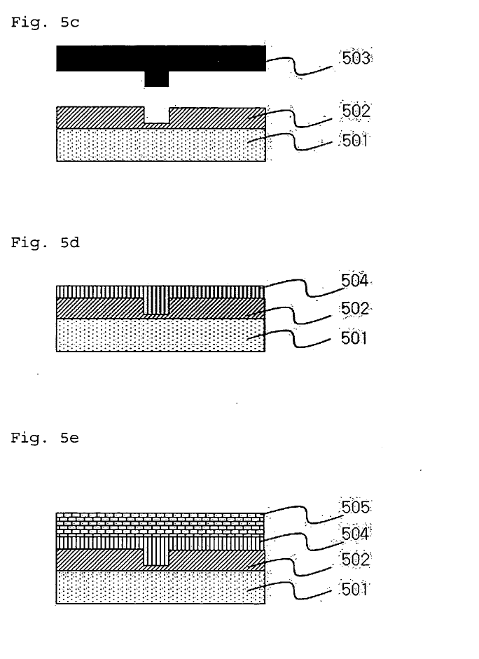

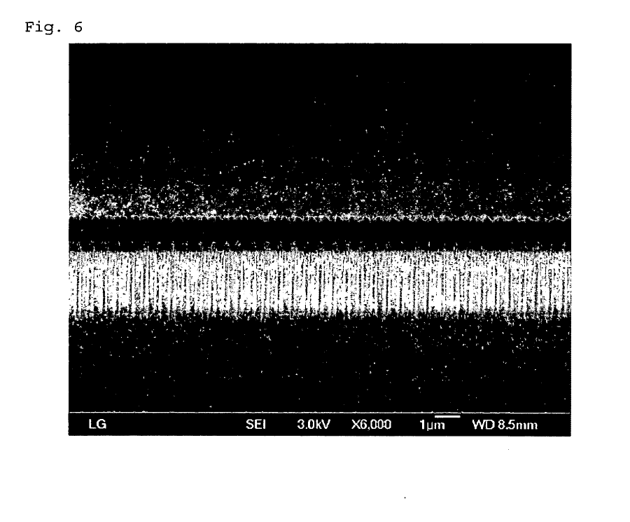

FIGS. 5a to 5e show the process of manufacturing a waveguide-type wavelength filter, according to the present invention.

A lower cladding layer 502 is applied on a substrate 501 (FIG. 5a). The substrate is preferably a silicon substrate.

Using the mold manufactured as above, the lower cladding layer 502 is patterned. Specifically, the pattern of the mold 503 is reprinted onto the lower cladding layer 502 using a thermal imprinting process or a UV imprinting process (FIG. 5b).

After the pattern of the mold 503 is set in the lower cladding layer 502 using heat or UV light, the mold 503 is removed (FIG. 5c). Then, a core layer 504 and an upper cladding layer 505 are sequentially formed, thus completing a desired device (FIGS. 5d and 5e).

The polymer material used to manufacture the wavelength filter should have low light loss in the wavelength range used. In addition, it is appropriate that the refractive index of the cladding layer be lower than that of the core layer 504 so that light is propagated in a single-mode manner to the core layer 504.

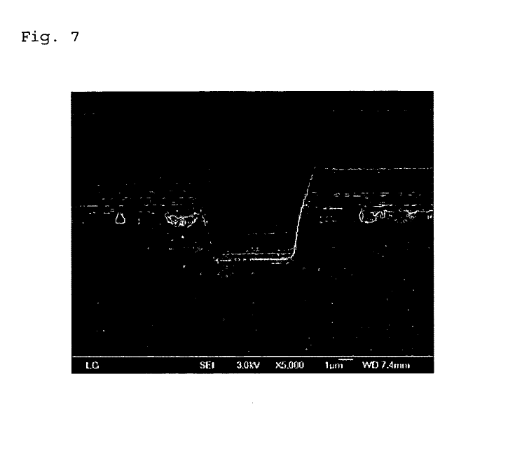

FIG. 6 is a photograph showing a quartz stamp manufactured using the process shown in FIGS. 3a to 3d, according to the first embodiment of the present invention. Since the stamp thus manufactured is transparent to UV light, it may be effectively used when the device is manufactured using UV imprinting.

FIG. 7 is a photograph showing the lower cladding layer patterned through UV imprinting using the stamp of FIG. 6. The core layer and the upper cladding layer are sequentially formed on the pattern of the lower cladding layer, thus completing a wavelength filter.

As described hereinbefore, the present invention provides methods of manufacturing a mold for patterning a lower cladding layer of a wavelength filter and of manufacturing a waveguide-type wavelength filter using the mold. According to the present invention, the waveguide-type wavelength filter formed of a polymer material can be inexpensively manufactured on a large scale.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing a mold for patterning a lower cladding layer of a wavelength filter, comprising:
etching a substrate, to form a grating pattern on the substrate;
preparing an etching mask for an optical waveguide pattern, and then etching the substrate using the etching mask; and
removing the etching mask.

2. The method as set forth in claim 1, wherein the substrate is a transparent substrate or a semiconductor substrate.

3. The method as set forth in claim 1, wherein the etching mask has a width equal to that of an optical waveguide.

4. The method as set forth in claim 1, wherein the etching of the substrate using the etching mask is conducted to a depth equal to a thickness of the optical waveguide overlapping the lower cladding layer.

5. The method as set forth in claim 1, wherein the formation of the grating pattern on the substrate is conducted using laser interference lithography.

6. The method as set forth in claim 1, wherein the etching mask comprises a chromium pattern.

7. A method of manufacturing a mold for patterning a lower cladding layer of a wavelength filter, comprising:
forming an optical waveguide pattern on a substrate;
applying a planarization polymer layer on the optical waveguide pattern, and then forming a grating pattern on the planarization polymer layer, and
removing the planarization polymer layer with the exception of the grating pattern formed on the optical waveguide pattern.

8. The method as set forth in claim 7, wherein the substrate is a transparent substrate or a semiconductor substrate.

9. The method as set forth in claim 7, wherein the optical waveguide pattern has a width equal to that of an optical waveguide.

10. The method as set forth in claim 7, wherein the optical waveguide pattern has a height equal to a thickness of the optical waveguide overlapping the lower cladding layer.

11. The method as set forth in claim 7, wherein the formation of the grating pattern is conducted using laser interference lithography.

12. The method as set forth in claim 7, wherein the grating pattern is formed only on the optical waveguide pattern.

13. A method of manufacturing a waveguide-type wavelength filter, comprising:
applying a lower cladding layer on a substrate;
patterning the lower cladding layer, using the mold manufactured using the method of claim 1 or 2;
setting a pattern of the mold in the lower cladding layer, and then removing the mold; and
sequentially forming a core layer and an upper cladding layer.

14. The method as set forth in claim 13, wherein the patterning of the lower cladding layer is conducted by reprinting the pattern of the mold onto the lower cladding layer using a thermal imprinting process or a UV imprinting process.

15. The method as set forth in claim 13, wherein the setting of the pattern of the mold is conducted using heat or UV light.
